(19) United States
(12) Patent Application Publication
(10) Pub. No.: US 2017/0310873 A1
(43) Pub. Date: Oct. 26, 2017

(54) TERMINAL APPARATUS, INFORMATION ACQUISITION SYSTEM, INFORMATION ACQUISITION METHOD, AND COMPUTER-READABLE RECORDING MEDIUM

(71) Applicant: OLYMPUS CORPORATION, Tokyo (JP)

(72) Inventors: Toshikazu HAYASHI, Tokyo (JP); Teruo TOMITA, Tokyo (JP); Seiji TATSUTA, Tokyo (JP); Osamu NONAKA, Sagamihara-shi (JP)

(73) Assignee: OLYMPUS CORPORATION, Tokyo (JP)

(21) Appl. No.: 15/493,694

(22) Filed: Apr. 21, 2017

(30) Foreign Application Priority Data
Apr. 25, 2016 (JP) 2016-087326

(51) Int. Cl. H04N 5/232; H04N 5/247; H04N 5/77

(52) U.S. Cl. CPC H04N 5/23203; H04N 5/77; H04N 5/23216; H04N 5/23293; H04N 5/247

(57) ABSTRACT

A terminal apparatus includes: an acquisition unit configured to obtain information; a communication unit configured to communicate with an external device, transmit the information obtained by the acquisition unit to the external device and receive external device information obtained on the external device when the acquisition unit obtains the information; and a recording control unit configured to associate the external device information received by the communication unit with the information obtained by the acquisition unit and record the associated information on a recording unit.

### CROSS-REFERENCE TO RELATED APPLICATION

This application is based upon and claims the benefit of priority from Japanese Patent Application No. 2016-087326, filed on Apr. 25, 2016, the entire contents of which are incorporated herein by reference.

### BACKGROUND

### 1. Technical Field

The present disclosure relates to a terminal apparatus, an information acquisition system, an information acquisition method, and a computer-readable recording medium.

### 2. Related Art

In recent, years, a technique of associating with each other a plurality of moving images and still images captured by a plurality of digital cameras (for example, refer to JP 2006-135394 A) has been known. The technique calculates shooting date/time of a moving image based on a creation date/time and recording time of a moving image file, and thereafter, searches, from a memory, a still image captured around the shooting date/time of this image, and then, classifies the images by associating the moving image with the still image.

### SUMMARY

A terminal apparatus according to one aspect of the present disclosure includes: an acquisition unit configured to obtain information; a communication unit configured to communicate with an external device, transmit the information obtained by the acquisition unit to the external device and receive external device information obtained on the external device when the acquisition unit obtains the information; and a recording control unit configured to associate the external device information received by the communication unit with the information obtained by the acquisition unit and record the associated information on a recording unit.

The above and other features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1A is a block diagram illustrating a functional configuration of an information acquisition system according to a first embodiment of the present disclosure;

FIG. 1B is a block diagram illustrating a functional configuration of the information acquisition system according to the first embodiment of the present disclosure;

FIG. 2 is a schematic diagram illustrating an exemplary general configuration of the information acquisition system according to the first embodiment of the present disclosure;

FIG. 3 is a schematic diagram illustrating another exemplary general configuration of the information acquisition system according to the first embodiment of the present disclosure;

FIG. 4 is a diagram illustrating control list information recorded by a first control information recording unit of a terminal apparatus according to the first embodiment of the present disclosure;

FIG. 5 is a diagram illustrating control list information recorded by a second control information recording unit of an attachment apparatus according to the first embodiment of the present disclosure;

FIG. 6A is a flowchart illustrating an outline of processing executed by the terminal apparatus according to the first embodiment of the present disclosure;

FIG. 6B is a flowchart illustrating an outline of processing executed by the terminal apparatus according to the first embodiment of the present disclosure;

FIG. 7 is a diagram illustrating a status in which the terminal apparatus and the attachment apparatus according to the first embodiment of the present disclosure are performing shooting in cooperation;

FIG. 8 is a diagram schematically illustrating an exemplary image displayed by a first display unit of the terminal apparatus according to the first embodiment of the present disclosure;

FIG. 9 is a flowchart illustrating an outline of processing executed by the attachment apparatus according to the first embodiment of the present disclosure;

FIG. 10 is a flowchart illustrating an outline of processing executed by an attachment apparatus according to a second embodiment of the present disclosure;

FIG. 11 is a diagram illustrating a status in which the terminal apparatus and the attachment apparatus according to the second embodiment of the present disclosure are performing shooting in cooperation;

FIG. 12 is a diagram illustrating an exemplary image displayed by a second display unit of the attachment apparatus according to the second embodiment of the present disclosure;

FIG. 13 is a diagram schematically illustrating first information and second information received by the attachment apparatus according to the second embodiment of the present disclosure; and

FIG. 14 is a diagram schematically illustrating an exemplary image file recorded by the attachment apparatus according to the second embodiment of the present disclosure.

### DETAILED DESCRIPTION

Hereinafter, embodiments of the present disclosure (hereinafter, referred to as embodiment(s)) will be described with reference to the drawings. Note that the present disclosure is not limited by these embodiments. In the description of the drawings, the same portions are given the same reference numerals.

### First Embodiment

Information Acquisition System

The present embodiment may provide a terminal apparatus capable of confirming mutual operation content at the time of information acquisitions even if information acquisitions are performed simultaneously in cooperation, an information acquisition system, an information acquisition method, and a recording medium.

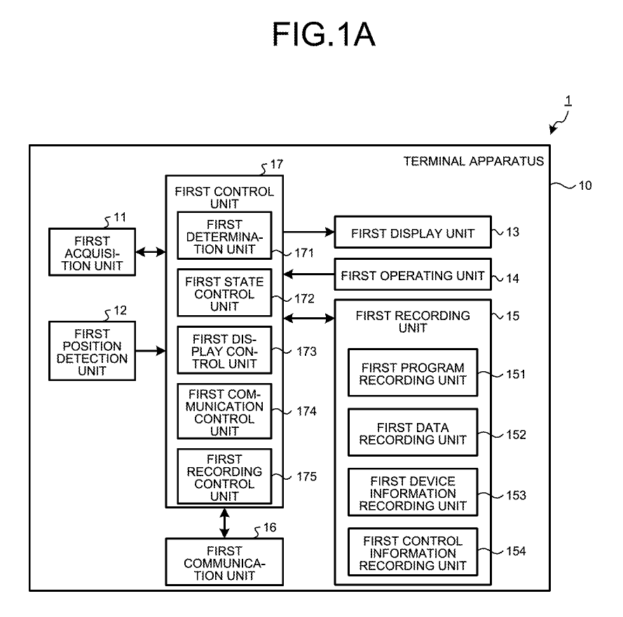

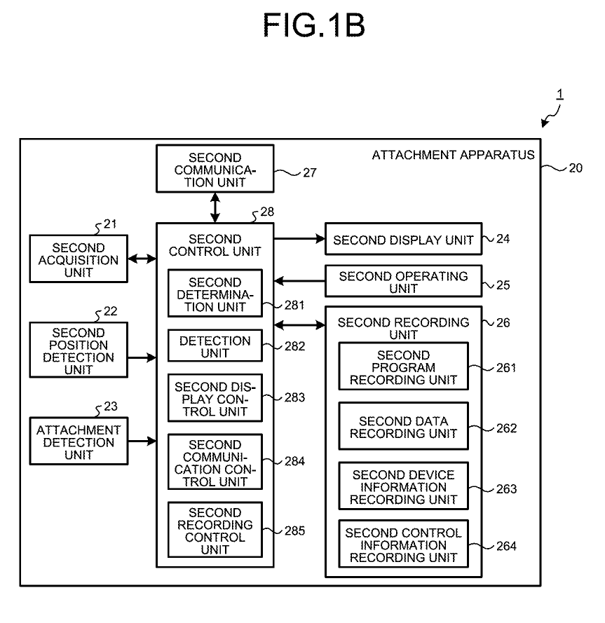

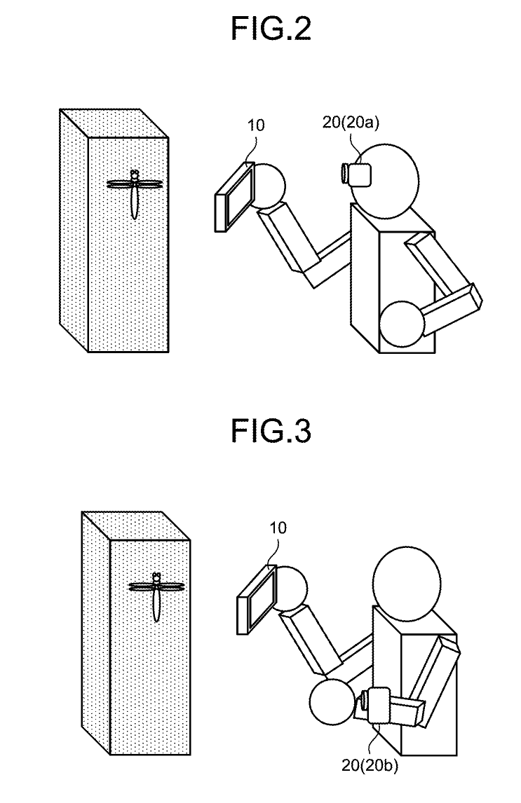

FIGS. 1A and 1B are block diagrams each illustrating a functional configuration of an information acquisition system according to a first embodiment of the present disclosure. An information acquisition system 1 illustrated in FIGS. 1A and 1B includes a terminal apparatus 10 held by a user, and an attachment apparatus 20 as an external device attached onto a user. In a case where the terminal apparatus 10 is a digital camera, as illustrated in FIGS. 2 and 3, when the attachment apparatus 20 is a head-mount display 20a (hereinafter, referred to as a “HMD 20a”), or the attachment apparatus 20 is a wearable terminal or a wrist watch 20b (hereinafter, referred to as a “watch 20b”) having an imaging function, the information acquisition system 1 according to the first embodiment operates in cooperation with each other while making judgment on user's intention by performing two-way communication of information obtained from each of the terminal apparatus 10 and the attachment apparatus 20 and operation results of the terminal apparatus 10 and the attachment apparatus 20 in accordance with predetermined wireless communication standards. Note that the exemplary predetermined wireless communication standards include IEEE802.11a, IEEE802.11b, IEEE802.11n, IEEE802.11g, IEEE802.11ac, Bluetooth (registered trademark) or infrared communication standards. Note that any wireless communication standard may be applied to the first embodiment.

Configuration of Terminal Apparatus

First, the terminal apparatus 10 will be described. The terminal apparatus 10 is provided as an apparatus having an imaging function capable of imaging the subject, or a voice input function capable of obtaining voice, when being held by the user. For example, the terminal apparatus 10 is provided using a digital camera, a mobile device, a smartphone, and an IC recorder. Note that hereinafter, the terminal apparatus 10 will be described as a digital camera or an IC recorder.

As illustrated in FIG. 1A, the terminal apparatus 10 includes a first acquisition unit 11, a first position detection unit 12, a first display unit 13, a first operating unit 14, a first recording unit 15, a first communication unit 16, and a first control unit 17.

The first acquisition unit 11 obtains image data by imaging the subject and outputs the image data to the first control unit 17. Alternatively, the first acquisition unit 11 obtains voice data and outputs the voice data to the first control unit 17. The first acquisition unit 11 includes a first optical system (not illustrated) constituted by one or more lenses and configured to collect light from a predetermined field area, a diaphragm configured to adjust the amount of incident light collected by the first optical system, a shutter that operates in accordance with the input of a release signal, an imaging element such as a charge coupled device (CCD) or a complementary metal oxide semiconductor (CMOS) that receives the light that passes through the diaphragm and the shutter and converts the light into electrical signals, and a signal processing unit configured to perform analog processing such as noise reduction processing and gain-up processing onto an analog signal output from the imaging element, perform A/D conversion onto the signal, and output the converted signal to the first control unit 17. Alternatively, the first acquisition unit 11 is constituted with a microphone, an A/D converter, or the like. Note that the first acquisition unit 11 functions as an acquisition unit in the first embodiment.

The first position detection unit 12 detects a position of the terminal apparatus 10 and outputs a detection result to the first control unit 17. The first position detection unit 12 is constituted with an orientation sensor, a GPS sensor, a gyro sensor, and an acceleration sensor, or the like.

Under the control of the first control unit 17, the first display unit 13 displays an image that corresponds to the image data obtained by the first acquisition unit 11 and various types of information regarding the terminal apparatus 10. The first display unit 13 includes a display panel of liquid crystal, organic electroluminescence (EL), or the like.

The first operating unit 14 is constituted with a power switch that receives an input of an instruction signals such as power on and off of the terminal apparatus 10, a switch that receives an input of an instruction signal to instruct imaging or sound recording to the first acquisition unit 11, a switch that receives an input of an instruction signal for the terminal apparatus 10 to communicate with other devices, or the like. Moreover, the first operating unit 14 receives an input of an instruction signal to instruct to change the state of the first acquisition unit 11 at the time when the first acquisition unit 11 obtains the first information. For example, the first operating unit 14 receives an input of an instruction signal to instruct a change in imaging parameters of the first acquisition unit 11, for example, an exposure value, ISO, a diaphragm value, a shutter speed, gain, and a focusing position. Note that the first operating unit 14 functions as an input unit in the first embodiment.

The first recording unit 15 records various types of information regarding the terminal apparatus 10. The first recording unit 15 is constituted with a semiconductor memory such as a flash memory and a dynamic random access memory (DRAM). The first recording unit 15 includes a first program recording unit 151, a first data recording unit 152, a first device information recording unit 153, a first control information recording unit 154. The first program recording unit 151 records various programs executed by the terminal apparatus 10. The first data recording unit 152 records various data obtained by the first acquisition unit 11. The first device information recording unit 153 records various types of information (e.g., device ID and password) regarding the terminal apparatus 10. The first control information recording unit 154 records control list information regarding control content corresponding to the device to operate in cooperation via the first communication unit 16.

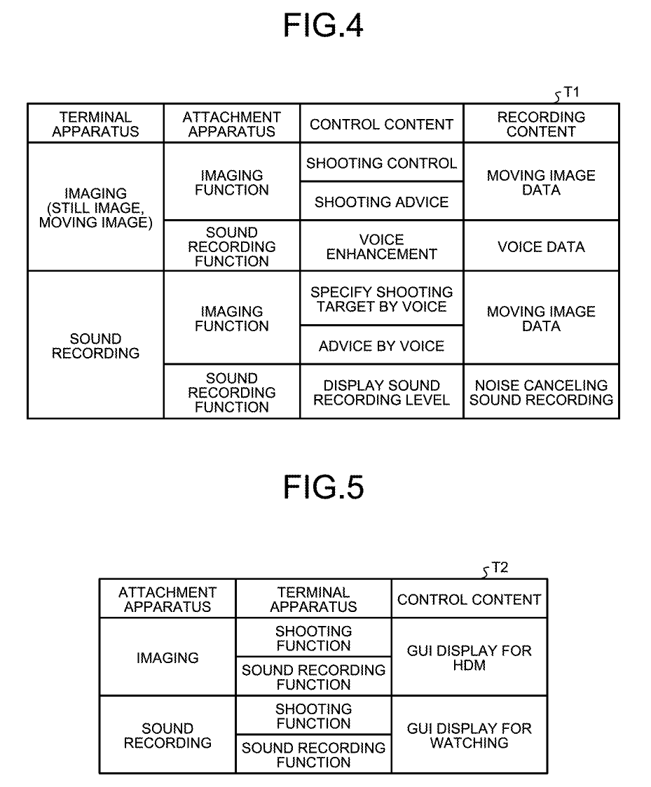

FIG. 4 is a diagram illustrating control list information recorded by the first control information recording unit 154. Control list information T1 illustrated in FIG. 4 describes control content individually performed in accordance with the function of the terminal apparatus 10 and the function of the attachment apparatus 20. Specifically, as illustrated in the control list information T1, when the terminal apparatus 10 performs imaging (still image or moving image) and the attachment apparatus 20 has an imaging function, the attachment apparatus 20 performs shooting control (AF processing, AE processing) of controlling a focusing position or exposure in shooting by the attachment apparatus 20, based on the first information (image data) received from the terminal apparatus 10, displays advice related to shooting, on an image displayed on the attachment apparatus 20, and the terminal apparatus 10 records the moving image data and still image data received from the attachment apparatus 20 in association with each other. Moreover, as illustrated in the control list information T1, when the terminal apparatus 10 performs imaging (still image or moving image) and the attachment apparatus 20 has a sound recording function, the attachment apparatus 20 performs voice control of enhancing the voice of a main subject (shooting target) captured on the image data at the time of sound recording by the attachment apparatus 20, based on the first information (image data) received from the terminal apparatus 10, and the terminal apparatus 10 records the voice data and still image data received from the attachment apparatus 20 in association with each other.

Furthermore, as illustrated in the control list information T1, when the terminal apparatus 10 performs sound recording and the attachment apparatus 20 has an imaging function, the attachment apparatus 20 performs shooting control (AF processing, AE processing) by specifying a shooting target by voice of the attachment apparatus 20, based on the first information (voice data) received from the terminal apparatus 10, displays advice related to sound recording or outputs advice by voice onto an image displayed on the attachment apparatus 20, and the terminal apparatus 10 records the moving image data and voice data received from the attachment apparatus 20 in association with each other. Still further, as illustrated in the control list information T1, when the terminal apparatus 10 performs sound recording and the attachment apparatus 20 has a sound recording function, the attachment apparatus 20 performs control of displaying a sound recording level by the attachment apparatus 20 based on the first information (voice data) received from the terminal apparatus 10, and the terminal apparatus 10 records the noise-canceled recorded sound data based on the voice data received from the attachment apparatus 20.

Returning back to FIG. 1A, description of the configuration of the terminal apparatus 10 will be continued.

The first communication unit 16 performs wireless communication with other devices such as the attachment apparatus 20 in accordance with a predetermined wireless communication standard and transmits the data to the attachment apparatus 20, and together with this, receives external device information including second information obtained on the attachment apparatus 20 when the first acquisition unit 11 obtains the first information and operation information regarding the operation performed on the attachment apparatus 20, and outputs the information to the first control unit 17. Note that the second information includes second image data or second voice data obtained on the attachment apparatus 20.

The first control unit 17 is a controller or a processor that executes various processes for controlling individual components of the terminal apparatus 10. The first control unit 17 includes a first determination unit 171, a first state control unit 172, a first display control unit 173, a first communication control unit 174, and a first recording control unit 175.

The first determination unit 171 determines the communication state between the first communication unit 16 and the attachment apparatus 20. Specifically, the first determination unit 171 determines whether it has received, as pairing information, a password needed for performing pairing for two-way communication from the attachment apparatus 20 via the first communication unit 16.

The first state control unit 172 controls the state of the first acquisition unit 11 based on the first information obtained by the first acquisition unit 11 and the second information transmitted from the attachment apparatus 20. Specifically, the first state control unit 172 controls shooting parameters (e.g., ISO, exposure value, shutter speed, and diaphragm) of the first acquisition unit 11 when the first acquisition unit 11 may generate image data of the subject, while the first state control unit 172 controls sound recording parameters (e.g., noise canceling and directional pattern) of the first acquisition unit 11 when the first acquisition unit 11 may perform sound recording of voice data.

The first display control unit 173 controls a display mode of the first display unit 13. Specifically, the first display control unit 173 displays, on the first display unit 13, an image that corresponds to the first information obtained by the first acquisition unit 11. Moreover, the first display control unit 173 combines the second information that is transmitted from the attachment apparatus 20 and that includes the operation information regarding the operation content that is operated on the attachment apparatus 20, with the first information, and displays the combined information on the first display unit 13. Specifically, the first display control unit 173 superposes the operation information included in the second information onto the image that corresponds to first image data, and displays the superposed image on the first display unit 13.

The first communication control unit 174 controls the communication state of the first communication unit 16. Specifically, the first communication control unit 174 transmits the first information obtained by the first acquisition unit 11 to the attachment apparatus 20 via the first communication unit 16.

The first recording control unit 175 associates the external device information received from the attachment apparatus 20 via the first communication unit 16 with the first information obtained by the first acquisition unit 11 and records the associated information on the first recording unit 15.

Configuration of Attachment Apparatus

Next, a configuration of the attachment apparatus 20 will be described.

Exemplary assumed attachment apparatuses 20 include an HMD, an IC recorder, and a biological information-obtainable wristwatch shaped terminal. The attachment apparatus 20 is used in a state of being worn by the user. Note that hereinafter, the attachment apparatus 20 will be described as an HMD. In addition, hereinafter, the attachment apparatus 20 will be described as an external device, while the attachment apparatus 20 functions also as a terminal apparatus according to the first embodiment.

As illustrated in FIG. 1B, the attachment apparatus 20 includes a second acquisition unit 21, a second position detection unit 22, an attachment detection unit 23, a second display unit 24, a second operating unit 25, a second recording unit 26, a second communication unit 27, and a second control unit 28.

The second acquisition unit 21 obtains image data by imaging a subject and outputs the image data to the second control unit 28, or obtains voice data and outputs the voice data to the second control unit 28. The second acquisition unit 21 includes a second optical system (not illustrated) constituted by one or more lenses and configured to collect light from a predetermined field area, a diaphragm configured to adjust the amount of incident light collected by the second optical system, a shutter that operates in accordance with the input of a release signal, an imaging element such as a CCD or a CMOS configured to receive the light that passes through the diaphragm and the shutter and convert the light into electrical signals, and a signal processing unit configured to perform analog processing such as noise reduction processing and gain-up processing onto an analog signal output from the imaging element, perform A/D conversion onto the signal, and output the converted signal to the second control unit 28. Alternatively, the second acquisition unit 21 is constituted with a microphone, an A/D converter, or the like. Moreover, the second acquisition unit 21 is configured such that the second optical system has a longer focal length than the focal length of the first optical system in the first acquisition unit 11. Specifically, the focal length of the second optical system is wide-angle setting (e.g., 8 mm to 24 mm), while the focal length of the first optical system is standard setting (e.g., 35 mm to 50 mm).

The second position detection unit 22 detects a position of the attachment apparatus 20 and outputs the detection result to the second control unit 28. The second position detection unit 22 is constituted with an orientation sensor, a GPS sensor, a gyro sensor, and an acceleration sensor, or the like.

The attachment detection unit 23 detects an attachment state of the attachment apparatus 20 by the user and vital information, and outputs the detection result to the second control unit 28. The attachment detection unit 23 is constituted with a pressure sensor, a vital sensor (heart rate detection sensor), an infrared sensor, a temperature sensor, or the like.

Under the control of the second control unit 28, the second display unit 24 displays the image that corresponds to the image data input from the second control unit 28 and various types of information regarding the attachment apparatus 20. The second display unit 24 is constituted with liquid crystal or organic EL.

The second operating unit 25 is constituted with a power switch that receives an input of instruction signals such as power on and off of the attachment apparatus 20, a switch that receives an input of an instruction signal to instruct, for example, to start shooting or sound recording to the second acquisition unit 21, a switch that receives an input of an instruction signal to communicate with the terminal apparatus 10, or the like. Note that the second operating unit 25 functions as an input unit in the first embodiment.

The second recording unit 26 records various types of information regarding the attachment apparatus 20. The second recording unit 26 is constituted with a semiconductor memory such as a flash memory and a DRAM. The second recording unit 26 includes a second program recording unit 261, a second data recording unit 262, a second device information recording unit 263, a second control information recording unit 264. The second program recording unit 261 records various programs to be executed by the attachment apparatus 20. The second data recording unit 262 records various data obtained by the second acquisition unit 21. The second device information recording unit 263 records a device ID to identify the attachment apparatus 20, a password needed for wirelessly communicating with other devices, or the like. The second control information recording unit 264 records control list information regarding control content that corresponds to the device operated in cooperation via the second communication unit 27.

FIG. 5 is a diagram illustrating control list information recorded by the second control information recording unit 264. Control list information T2 illustrated in FIG. 5 describes control content individually performed in accordance with the function of the attachment apparatus 20 and the function of the terminal apparatus 10. Moreover, as illustrated in the control list information T2, when the terminal apparatus 10 has a shooting function or a sound recording function when the attachment apparatus 20 performs imaging, the terminal apparatus 10 displays graphic user interface (hereinafter, referred to as GUI) for HDM, on the first display unit 13. Moreover, as illustrated in the control list information T2, when the terminal apparatus 10 has a shooting function or a sound recording function when the attachment apparatus 20 performs sound recording, the terminal apparatus 10 displays a GUI for watching, on the first display unit 13.

The second communication unit 27 performs wireless communication with other devices, for example, the terminal apparatus 10 in accordance with a predetermined wireless communication standard and transmits data to the terminal apparatus 10, and together with this, receives the data transmitted from the terminal apparatus 10 and outputs the data to the second control unit 28.

The second control unit 28 is a controller or a processor that executes various processes for controlling individual components of the attachment apparatus 20. The second control unit 28 includes a second determination unit 281, a detection unit 282, a second display control unit 283, a second communication control unit 284, and a second recording control unit 285.

The second determination unit 281 determines the communication state between the second communication unit 27 and the terminal apparatus 10. Specifically, the second determination unit 281 determines whether it has received, as pairing information, a password needed for performing pairing for two-way communication from the terminal apparatus 10 via the second communication unit 27.

The detection unit 282 detects a shooting area of the first image on the second image that corresponds to the second information obtained by the second acquisition unit 21. Specifically, the detection unit 282 detects the shooting area of the first image on the second image by performing processing of pattern matching or feature data extraction individually in the second image and the first image obtained by the second acquisition unit 21. Alternatively, the detection unit 282 may detect the shooting area of the first image on the second image using known techniques such as pixel matching for each of the second image and the first image.

The second display control unit 283 controls a display mode of the second display unit 24. Specifically, the second display control unit 283 displays, on the second display unit 24, the second image that corresponds to the second information obtained by the second acquisition unit 21.

The second communication control unit 284 controls the communication state of the second communication unit 27. Specifically, the second communication control unit 284 transmits the second information obtained by the second acquisition unit 21 to the terminal apparatus 10 via the second communication unit 27.

The second recording control unit 285 associates the first information transmitted from the terminal apparatus 10 via the second communication unit 27, operation information including operation content performed on the terminal apparatus 10, and the second information obtained by the second acquisition unit 21 with each other, and records the associated information on the second recording unit 26.

Processing of Terminal Apparatus

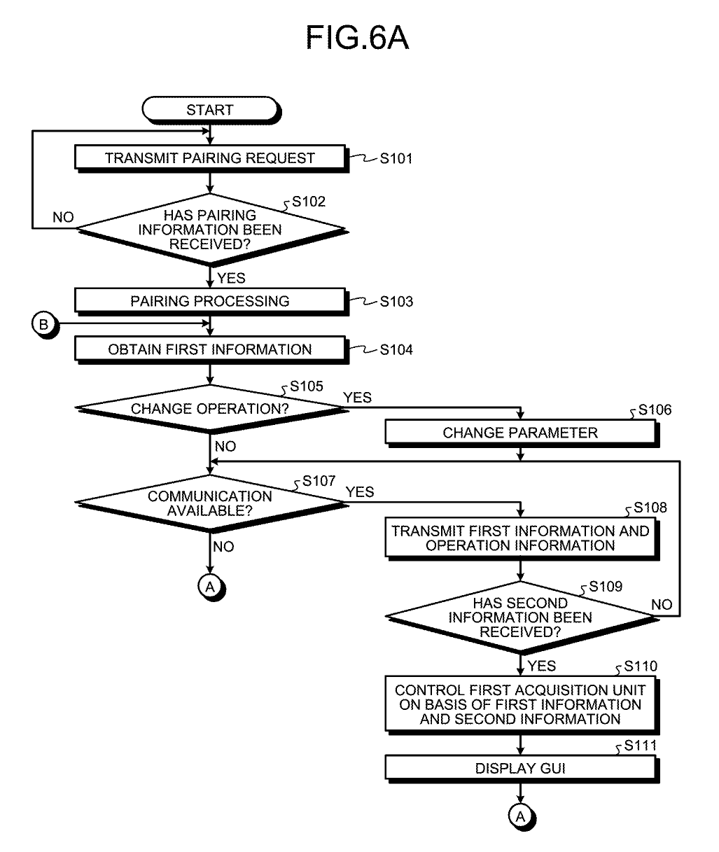

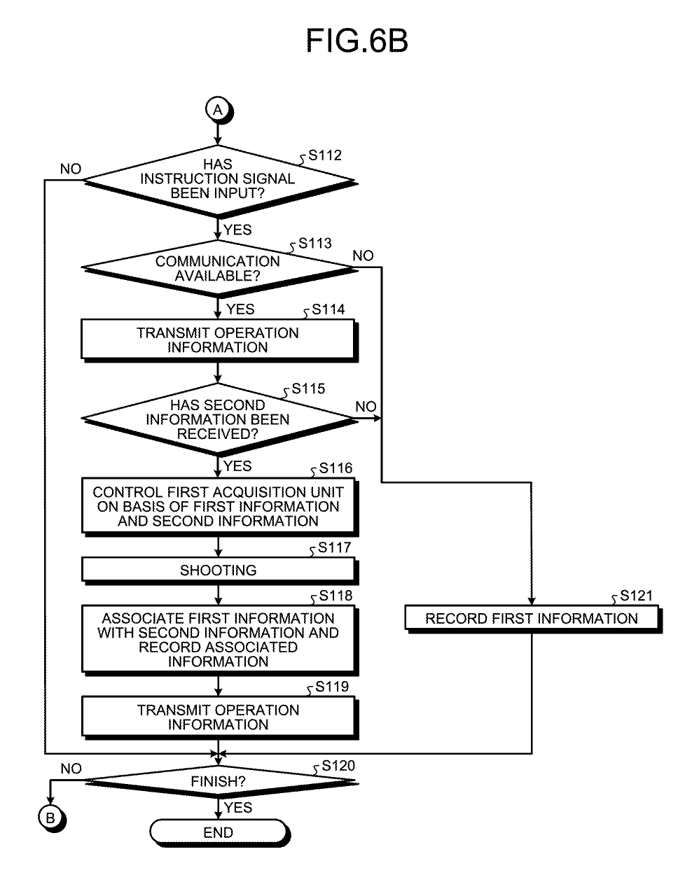

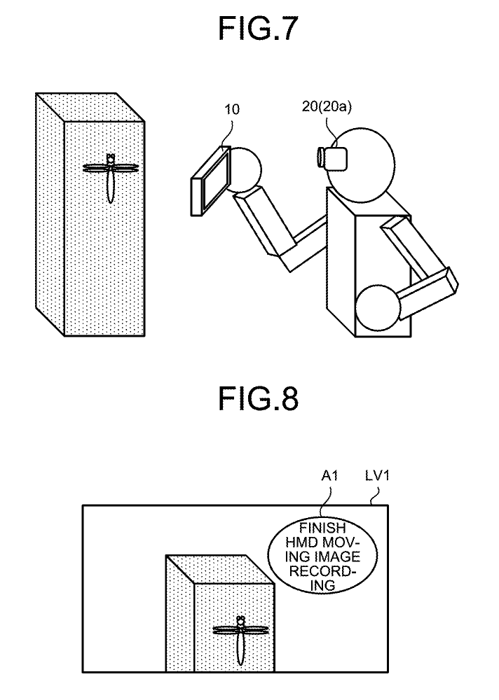

Next, processing executed by the terminal apparatus 10 will be described. FIGS. 6A and 6B are flowcharts illustrating an outline of the processing executed by the terminal apparatus 10. As illustrated in FIGS. 6A and 6B, the terminal apparatus 10 transmits a pairing request to the attachment apparatus 20 (Step S101). Specifically, as illustrated in FIG. 7, the terminal apparatus 10 transmits device information regarding the terminal apparatus 10 to the attachment apparatus 20 via the first communication unit 16.

Subsequently, the first determination unit 171 determines whether the pairing information has been received from the attachment apparatus 20 via the first communication unit 16 (Step S102). Specifically, the first determination unit 171 determines whether it has received, as pairing information, a password needed for performing pairing for two-way communication from the attachment apparatus 20 via the first communication unit 16. When the first determination unit 171 determines that the pairing information has been received from the attachment apparatus 20 via the first communication unit 16 (Step S102: Yes), the terminal apparatus 10 moves on to Step S103 described below. In contrast, when the first determination unit 171 determines that the pairing information has not been received from the attachment apparatus 20 via the first communication unit 16 (Step S102: No), the terminal apparatus 10 returns to Step S101.

In Step S103, the first communication control unit 174 executes pairing processing of performing two-way communication with the attachment apparatus 20 based on the pairing information received via the first communication unit 16. This achieves two-way data transfer between the terminal apparatus 10 and the attachment apparatus 20.

Subsequently, the first acquisition unit 11 images the subject and obtains the first information (Step S104). Specifically, the first acquisition unit 11 images the subject and obtains the image data of the subject as the first information.

Thereafter, when parameter change operation of changing a parameter of the terminal apparatus 10 is performed from the first operating unit 14 (Step S105: Yes), the first control unit 17 changes the parameter of the terminal apparatus 10 based on the operation signal input from the first operating unit 14 (Step S106). Specifically, the first state control unit 172 changes the shooting parameters of the first acquisition unit 11 (e.g., ISO, exposure value, diaphragm value, shutter speed, and gain adjustment) based on the operation signal input from the first operating unit 14. After Step S106, the terminal apparatus 10 moves on to Step S107 described below. In contrast, when the parameter change operation of changing the parameter of the terminal apparatus 10 is not performed from the first operating unit 14 (Step S105: No), the terminal apparatus 10 moves on to Step S107 described below.

In Step S107, when the terminal apparatus 10 may communicate with the attachment apparatus 20 (Step S107: Yes), the first communication control unit 174 transmits the first information obtained by the first acquisition unit 11 and operation information obtained by the first operating unit 14 individually to the attachment apparatus 20 via the first communication unit 16 (Step S108).

Subsequently, when the second information has been received from the attachment apparatus 20 via the first communication unit 16 (Step S109: Yes), the terminal apparatus 10 moves on to Step S110 described below. In contrast, when the second information has not been received from the attachment apparatus 20 via the first communication unit 16 (Step S109: No), the terminal apparatus 10 returns to Step S107 described above.

In Step S110, the first state control unit 172 controls the first acquisition unit 11 based on the first information and the second information. Specifically, the first state control unit 172 performs shooting control (AF processing or AE processing) of controlling a focusing position or exposure of the first acquisition unit 11 toward a main subject based on the first image data included in the first information and the second image data included in the second information. For example, the first state control unit 172 calculates a distance from the terminal apparatus 10 to the main subject using known techniques such as phase difference detection based on the first image data and the second image data, thereby allowing the focusing position of the first acquisition unit 11 to be focused on the main subject.

Subsequently, the first display control unit 173 superposes the GUI related to the attachment apparatus 20 to be displayed on the image displayed by the first display unit 13 (Step S111). Specifically, as illustrated in FIG. 8, the first display control unit 173 superposes an icon A1 that receives an input of an instruction signal to finish recording of captured moving image by the attachment apparatus 20, onto a live-view image LV1, as the GUI related to the attachment apparatus 20, to be displayed on the first display unit 13. This enables the user to perform operation of the attachment apparatus 20 by operating the icon A1 of the terminal apparatus 10 without operating on the attachment apparatus 20. Furthermore, the user may intuitively grasp the state of the attachment apparatus 20 while viewing the terminal apparatus 10. After Step S111, the terminal apparatus 10 moves on to Step S112 described below.

In Step S107, when the terminal apparatus 10 cannot communicate with the attachment apparatus 20 (Step S107: No), the terminal apparatus 10 moves on to Step S112 described below.

In Step S112, when an instruction signal to instruct shooting or sound recording is input from the first operating unit 14 (Step S112: Yes) and when the apparatus may communicate with the attachment apparatus 20 (Step S113: Yes), the first communication control unit 174 transmits operation information including operation content indicating that the instruction signal to indicate shooting or recording has been input from the first operating unit 14 and including the current parameter of the first acquisition unit 11, to the attachment apparatus 20 (Step S114).

Subsequently, when the second information has been received from the attachment apparatus 20 via the first communication unit 16 (Step S115: Yes), the first state control unit 172 controls the state of the first acquisition unit 11 based on the first information and the second information (Step S116). Specifically, the first state control unit 172 performs shooting control (AF processing or AE processing) of controlling a focusing position or exposure of the first acquisition unit 11 toward the main subject based on the first image data included in the first information and the second image data included in the second information.

Thereafter, the first state control unit 172 causes the first acquisition unit 11 to execute shooting (Step S117).

Subsequently, the first recording control unit 175 associates the second information received from the attachment apparatus 20 via the first communication unit 16 with the first information obtained by the first acquisition unit 11 and records the associated information on the first recording unit 15 (Step S118).

Thereafter, the first communication control unit 174 transmits the operation information to the attachment apparatus 20 via the first communication unit 16 (Step S119).

Subsequently, when the processing is going to be finished via the first operating unit 14 (Step S120: Yes), the terminal apparatus 10 finishes the current processing. In contrast, when the processing is not going to be finished via the first operating unit 14 (Step S120: No), the terminal apparatus 10 returns to Step S104 described above.

In Step S112, when the instruction signal indicating shooting or sound recording has not been input from the first operating unit 14 (Step S112: No), the terminal apparatus 10 moves on to Step S120.

In Step S113, when it is not possible to communicate with the attachment apparatus 20 (Step S113: No), the terminal apparatus 10 moves on to Step S121 described below.

In Step S115, when the second information has not been received from the attachment apparatus 20 via the first communication unit 16 (Step S115: No), the terminal apparatus 10 moves on to Step S121 described below.

In Step S121, the first recording control unit 175 records the first information obtained by the first acquisition unit 11, on the first recording unit 15. After Step S121, the terminal apparatus 10 moves on to Step S120.

Processing of Attachment Apparatus

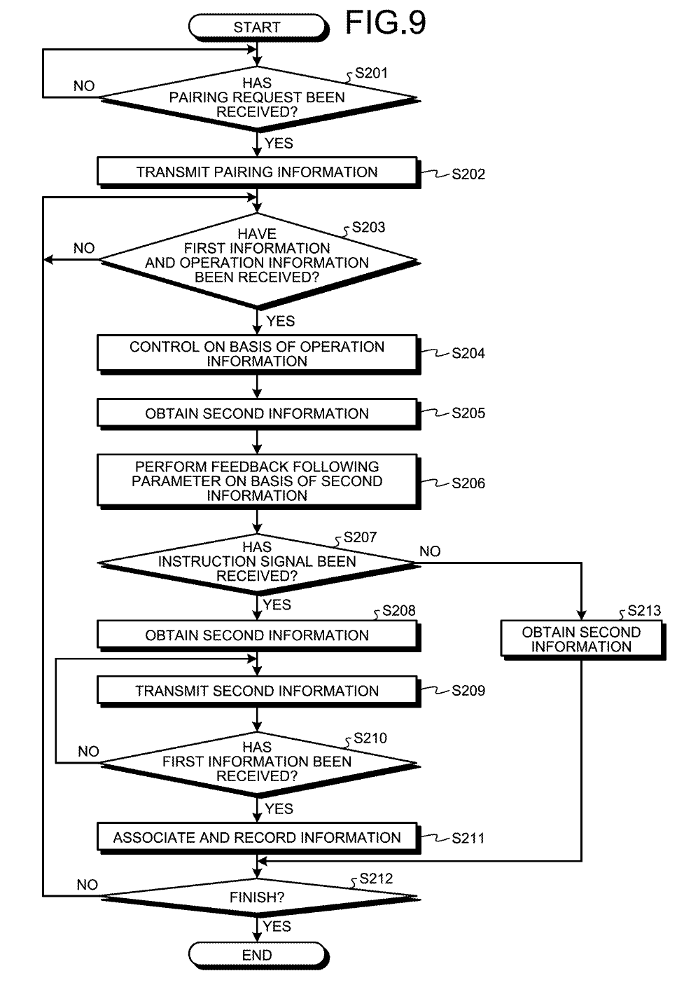

Next, processing of the attachment apparatus 20 will be described. FIG. 9 is a flowchart illustrating an outline of processing executed by the attachment apparatus 20. As illustrated in FIG. 9, when the attachment apparatus 20 receives a pairing request from the terminal apparatus 10 via the second communication unit 27 (Step S201: Yes), the second control unit 28 transmits pairing information to the terminal apparatus 10 via the second communication unit 27 (Step S202). In contrast, when the attachment apparatus 20 has not received any pairing request from the terminal apparatus 10 via the second communication unit 27 (Step S201: No), the attachment apparatus 20 continues this judgment.

Subsequently, when the first information and operation information have been received from the terminal apparatus 10 via the second communication unit 27 (Step S203: Yes), the second control unit 28 controls the attachment apparatus 20 based on the operation information (Step S204). Specifically, the second control unit 28 controls parameters of the second acquisition unit 21 (e.g., ISO, exposure value, diaphragm value, shutter speed, and gain adjustment).

Thereafter, the second acquisition unit 21 obtains the second information of the subject (Step S205).

Specifically, the second acquisition unit 21 images the subject and generates the image data of the subject as the second information.

Subsequently, the second control unit 28 performs feedback following the parameter of the attachment apparatus 20 based on the second information obtained by the second acquisition unit 21 (Step S206). For example, when the second acquisition unit 21 obtains vital information as the second information, the second display control unit 283 feeds back or displays the vital information onto the image displayed by the second display unit 24. Moreover, when the second acquisition unit 21 obtains the second image data as information and when the imaging area of the image that corresponds to the image data received from the terminal apparatus 10 overlaps with the imaging area of the image that corresponds to the image data obtained by the second acquisition unit 21, the second control unit 28 may emphasize the display of the overlapping imaging area, for example, by displaying a frame, an icon, or changing any of saturation, brightness, and contrast.

Thereafter, when an instruction signal indicating shooting or sound recording has been received from the terminal apparatus 10 via the second communication unit 27 (Step S207: Yes), the second acquisition unit 21 obtains the second information (Step S208).

Subsequently, the second control unit 28 transmits the second information obtained by the second acquisition unit 21, via the second communication unit 27 (Step S209).

Thereafter, when the first information has been received from the terminal apparatus 10 via the second communication unit 27 (Step S210: Yes), the second recording control unit 285 associates the second information obtained by the second acquisition unit 21, the first information received from the terminal apparatus 10, and operation information received from the terminal apparatus 10 with each other and records the associated information into the second recording unit 26 (Step S211).

Subsequently, when the processing is to be finished by the operation of the second operating unit 25 (Step S212: Yes), the attachment apparatus 20 finishes the current processing. In contrast, when the processing is not to be finished with no operation of the second operating unit 25 (Step S212: No), the attachment apparatus 20 returns to Step S203 described above.

In Step S203, when the first information and the operation information have not been received from the terminal apparatus 10 via the second communication unit 27 (Step S203: No), the attachment apparatus 20 continues this judgment.

In Step S207, when an instruction signal indicating shooting or sound recording has not been received from the terminal apparatus 10 via the second communication unit 27 (Step S207: No), the second acquisition unit 21 obtains the second information (Step S213). After Step S213, the attachment apparatus 20 moves on to Step S212.

In Step S210, when the first information has not been received from the terminal apparatus 10 via the second communication unit 27 (Step S210: No), the attachment apparatus 20 returns to Step S209.

According to the above-described first embodiment of the present disclosure, the first recording control unit 175 associates the first information obtained by the first acquisition unit 11, the second information transmitted from the attachment apparatus 20, and the operation information representing the operation content that is operated on the attachment apparatus 20 with each other and records the associated information on the first recording unit 15, or the second recording control unit 285 associates the second information obtained by the second acquisition unit 21, the first information transmitted from the terminal apparatus 10, and the operation information representing the operation content that is operated on the terminal apparatus 10 with each other and records the associated information on the second recording unit 26. Accordingly, it is possible to grasp mutual operation content at the time of information acquisitions even when the information acquisitions are performed simultaneously.

Moreover, according to the first embodiment of the present disclosure, it is possible to enrich the information by obtaining cooperation information at terminal apparatus operation, from an external device. Since it is sufficient to obtain enriched information like this, it is allowable to configure such that a control unit inside the external device obtains recording information associating this external device information with the information obtained by the acquisition unit, or that a third device combines the multiple types of information. Since the first display control unit 173 displays the operation information received from the attachment apparatus 20 by superposing it to be displayed on the image displayed by the first display unit 13, it is possible to intuitively grasp the operation content on the attachment apparatus 20.

### Second Embodiment

Next, a second embodiment of the present disclosure will be described. An information acquisition system according to the second embodiment has a configuration similar to the configuration of the information acquisition system 1 according to the above-described first embodiment, except for a difference in processing executed by the attachment apparatus 20. Hereinafter, processing executed by an attachment apparatus according to the second embodiment will be described. A same reference sign will be given to the configuration identical to the configuration of the information acquisition system 1 according to the above-described first embodiment, and description for this will be omitted.

Processing of Attachment Apparatus

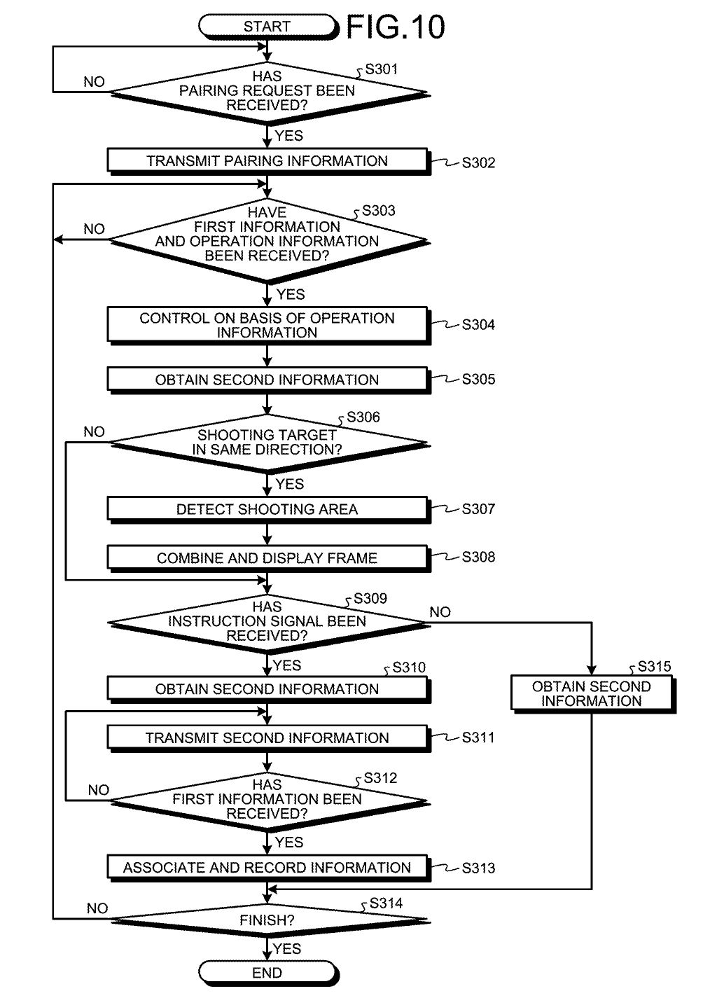

FIG. 10 is a flowchart illustrating an outline of processing executed by the attachment apparatus 20. In FIG. 10, Steps S301 and S302 correspond to Steps S201 and S202 in the above-described FIG. 9, respectively.

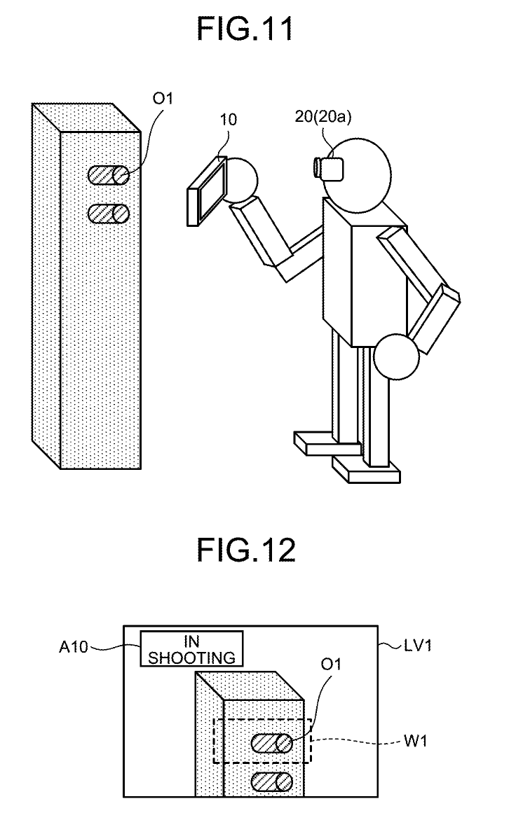

In Step S303, when the first information and operation information have been received from the terminal apparatus 10 via the second communication unit 27 (Step S303: Yes), the second control unit 28 controls the attachment apparatus 20 based on the operation information (Step S304). Specifically, as illustrated in FIG. 11, when operation information has been received from the terminal apparatus 10 by operation of the user on the terminal apparatus 10, the second control unit 28 controls a parameter of the attachment apparatus 20 based on the operation information. For example, when the user images a subject 01 using the terminal apparatus 10 and when the operation information received from the terminal apparatus 10 corresponds to the operation of increasing the exposure value, the second control unit 28 performs control of increasing the parameter for the exposure value of the second acquisition unit 21.

Subsequently, the second control unit 28 causes the second acquisition unit 21 to obtain the second information (Step S305).

Thereafter, the second determination unit 281 determines whether the terminal apparatus 10 is shooting a target in a direction same as the direction of the attachment apparatus 20 based on the acquisition information received from the terminal apparatus 10 and on the acquisition information obtained by the second acquisition unit 21 (Step S306). Specifically, the second determination unit 281 calculates a matching level between the first image that corresponds to the image data included in the first information received from the terminal apparatus 10 and the second image that corresponds to the image data included in the second information obtained by the second acquisition unit 21, and determines whether the calculated matching level is a predetermined threshold or above. Specifically, using an image that corresponds to the image data received from the terminal apparatus 10, the second determination unit 281 calculates the matching level for the image that corresponds to the image data obtained by the second acquisition unit 21 using known techniques such as pattern matching, subject detection, feature data extraction, and luminance information. In this case, the second determination unit 281 determines whether the terminal apparatus 10 is shooting the target in a direction same as the direction of the attachment apparatus 20, and in the case of a predetermined threshold or above, the second determination unit 281 determines that the terminal apparatus 10 is shooting the target in the direction same as the direction of the attachment apparatus 20. When the second determination unit 281 determines that the terminal apparatus 10 is shooting a target in the direction same as the direction of the attachment apparatus 20 (Step S306: Yes), the attachment apparatus 20 moves on to Step S307 described below. In contrast, when the second determination unit 281 determines that the terminal apparatus 10 is not shooting a target in a direction same as the direction of the attachment apparatus 20 (Step S306: No), the attachment apparatus 20 moves on to Step S309 described below.

In Step S307, the detection unit 282 detects a shooting area in which the first image that corresponds to the image data included in the first information received from the terminal apparatus 10 matches the second image that corresponds to the image data included in the second information obtained by the second acquisition unit 21. For example, the detection unit 282 extracts a feature point of the second image and a feature point of the first image, and detects an area with a same feature point as a shooting area of the first image. Note that the detection unit 282 may assume and detect the shooting area on the second image based on the field angle of the first acquisition unit 11 and the distance to the subject included in the first information.

Subsequently, the second display control unit 283 superposes a frame that corresponds to the shooting area of the terminal apparatus 10 onto the second image, and displays it on the second display unit 24 based on a detection result obtained by the detection unit 282 (Step S308). Specifically, as illustrated in FIG. 12, the second display control unit 283 superposes a frame W1 and information A10 onto the live-view image LV1 that corresponds to the image data obtained by the second acquisition unit 21 to be displayed on the second display unit 24. The frame W1 corresponds to the shooting area of the terminal apparatus 10, detected by the detection unit 282. The information A10 indicates that the terminal apparatus 10 is performing shooting. With this configuration, the user may perform shooting while checking the shooting area of the terminal apparatus 10 on the live-view image LV1 displayed on the second display unit 24 of the attachment apparatus 20. After Step S308, the attachment apparatus 20 moves on to Step S309 to be described below.

In Step S309, when an instruction signal indicating shooting or sound recording has been received from the terminal apparatus 10 via the second communication unit 27 (Step S309: Yes), the second control unit 28 causes the second acquisition unit 21 to obtain the second information (Step S310).

Subsequently, the second control unit 28 transmits the second information obtained by the second acquisition unit 21 to the terminal apparatus 10 via the second communication unit 27 (Step S311).

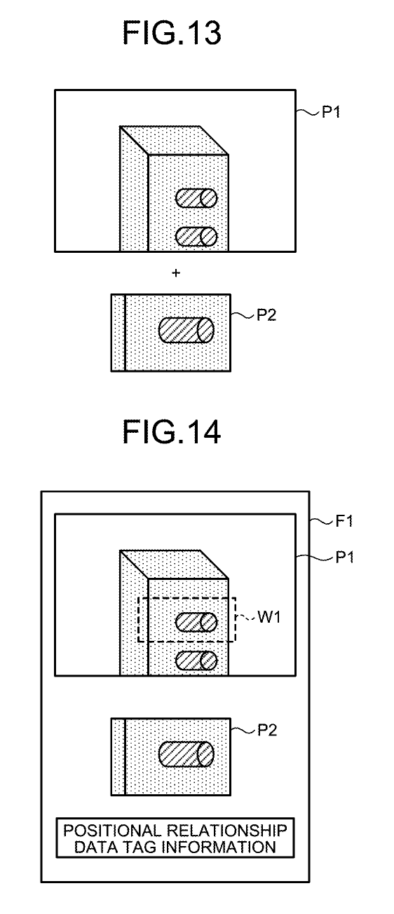

Thereafter, when the first information has been received from the terminal apparatus 10 via the second communication unit 27 (Step S312: Yes), the second recording control unit 285 associates the second information obtained by the second acquisition unit 21, the first information received from the terminal apparatus 10 via the second communication unit 27, operation information representing operation content that is operated on the terminal apparatus 10, and a positional relationship data tag as a result of detection obtained by the detection unit 282 (coordinate information of the shooting area of the first image on the second image) with each other and records the associated information on the second recording unit 26 (Step S313). Specifically, as illustrated in FIGS. 13 and 14, a file F1 is generated by associating an image P1 that corresponds to the image data obtained by the second acquisition unit 21, an image P2 that corresponds to the image data received from the terminal apparatus 10 via the second communication unit 27, and positional relationship information (positional relationship data tag information) including the position that corresponds to the shooting area of the terminal apparatus 10 and operation information regarding operation performed on the terminal apparatus 10, on the image P1, with each other, and then, the generated file F1 is recorded on the second data recording unit 262. After Step S313, the attachment apparatus 20 moves on to Step S314.

Steps S314 and S315 correspond to Steps S212 and S213 in the above-described FIG. 9, respectively.

According to the above-described second embodiment of the present disclosure, the first recording control unit 175 associates the first information obtained by the first acquisition unit 11, the second information transmitted from the attachment apparatus 20, and the operation information representing the operation content that is operated on the attachment apparatus 20 with each other and records the associated information on the first recording unit 15, or the second recording control unit 285 associates the second information obtained by the second acquisition unit 21, the first information transmitted from the terminal apparatus 10, and the operation information representing the operation content that is operated on the terminal apparatus 10 with each other and records the associated information on the second recording unit 26. Accordingly, it is possible to grasp mutual operation content at the time of information acquisitions even when the information acquisitions are performed simultaneously.

Moreover, according to the second embodiment of the present disclosure, the second display control unit 283 superposes a frame W1 onto the live-view image LV1 that corresponds to the image data obtained by the second acquisition unit 21 to be displayed on the second display unit 24. The frame W1 corresponds to the shooting area of the terminal apparatus 10, detected by the detection unit 282. With this configuration, the user may perform shooting while checking the shooting area of the terminal apparatus 10 on the live-view image LV1 displayed on the second display unit 24 of the attachment apparatus 20.

### Other Embodiments

Note that while the external device is described as an attachment apparatus in the above-described embodiment, the attachment apparatus is interchangeable with a terminal apparatus in the description. That is, it is possible to implement application when functions of the attachment apparatus are incorporated into the terminal apparatus. Specifically, functions of the first state control unit of the terminal apparatus may be incorporated into the attachment apparatus, or functions of the detection unit of the attachment apparatus may be incorporated into the terminal apparatus. Moreover, in the present embodiment, when the external device functions as a terminal apparatus, the first information is applied instead of the second information. Furthermore, when the terminal apparatus functions as an external device, the second information is applied instead of the first information.

Moreover, while a case where wireless communication is mainly used has been described to this point, the present embodiment may be achieved even by wired communication. Moreover, when each of the apparatuses may change its posture, orientation, and stability independently, it is possible to apply the present embodiment. Moreover, it is allowable to configure such that an information processing apparatus selects a certain apparatus by determining posture relationship between the respective apparatuses as communication candidates, or determining a fixing state of each of the apparatuses.

Alternatively, the terminal apparatus or the attachment apparatus may perform control reflecting communication signal intensity or positional relationships. In this case, it is allowable to configure to provide a human communication unit/touch sensor configured to determine whether the user is in a state of grasping each of the apparatuses, and a barometric pressure sensor configured to detect an altitude relation between the apparatuses, and perform communication and operation control, and cooperation control based on the positional relationship between the apparatuses using any of the above sensors.

Additionally, it is sufficient that the function of controlling the whole information acquisition system is incorporated in any of the apparatuses configuring the information acquisition system.

Note that when the terminal apparatus is a mobile information terminal, or the like, including a smartphone, it is allowable to configure such that the terminal apparatus obtains the function of controlling operation of the information acquisition system according to the present embodiment by downloading application software via a network.

It is also possible to configure a communication system according to the present embodiment using an information acquisition apparatus other than the imaging apparatus. Exemplary information acquisition apparatuses include an IC recorder, a thermometer, and a scale.

Alternatively, it is allowable to configure in the present embodiment that the first communication unit performs at least a portion of communication of various instruction signals without limiting the first communication unit to being specialized in image data transmission/reception.

While some embodiments of the present disclosure have been described in detail with reference to the drawings, these embodiments are provided for an exemplifying purpose. The present disclosure may be implemented in other modes to which various modifications and enhancements are applied based on the knowledge of those who are skilled in the art including the modes described in the summary of the present disclosure.

Moreover, the above-described “unit” is interchangeable with a “means” and a “circuit”. For example, the control unit is interchangeable with a control means and a control circuit.

The flowcharts herein clarify the sequence of processing in each of Steps by using expressions of “first”, “thereafter”, “subsequently”, or the like. However, the order of processing needed for achieving the above-described embodiments is not intended to be uniquely defined to this order by these expressions. In other words, the order of processing in the flowcharts described herein may be changed within a range implementable without contradiction.

Furthermore, the algorithm of the processing described with reference to the flowchart herein, may be described as a program. Such a program may be recorded in the storage unit inside the computer or may be recorded on a computer-readable recording medium. Recording of the program to the storage unit or recording medium may be performed at shipment of the computer or the recording medium as a product, or may be performed by downloading via a communication network.

In this manner, the present disclosure in its broader aspects is not limited to the representative embodiments described herein. Accordingly, various modifications may be made without departing from the spirit or scope of the general inventive concept as defined by the appended claims and their equivalents.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A terminal apparatus comprising:
an acquisition unit configured to obtain information;
a communication unit configured to communicate with an external device, transmit the information obtained by the acquisition unit to the external device and receive external device information obtained on the external device when the acquisition unit obtains the information; and
a recording control unit configured to associate the external device information received by the communication unit with the information obtained by the acquisition unit and record the associated information on a recording unit.

2. The terminal apparatus according to claim 1, further comprising:
a display unit configured to display the information obtained by the acquisition unit; and
a display control unit configured to combine the external device information with the information obtained by the acquisition unit and display the combined information on the display unit.

3. The terminal apparatus according to claim 2, further comprising an input unit configured to receive an input of an instruction signal for instructing a change of a state of the acquisition unit when the acquisition unit obtains the information,
wherein the communication unit further transmits, to the external device, first operation information including operation content that corresponds to the instruction signal.

4. The terminal apparatus according to claim 3, further comprising a state control unit configured to control a state of the acquisition unit based on the information obtained by the acquisition unit and the external device information.

5. The terminal apparatus according to claim 4,
wherein the acquisition unit images a subject and obtains first image data of the subject as the information,
the external device information includes second image data including the subject, and
the state control unit controls a focusing position or exposure at the time when the acquisition unit images the subject, based on the first image data and the second image data.

6. The terminal apparatus according to claim 5,
wherein the acquisition unit includes a first optical system configured to form a subject image of the subject, and
the external device includes a second optical system having a focal length shorter than a focal length of the first optical system.

7. The terminal apparatus according to claim 5, further comprising a detection unit configured to detect a shooting area of a second image corresponding to the second image data on a first image corresponding to the first image data,
wherein the display control unit displays, on the display unit, a result of detection corresponding to the shooting area detected by the detection unit by displaying the result of detection on the first image.

8. The terminal apparatus according to claim 7, wherein the recording control unit associates the result of detection obtained by the detection unit, the external device information received by the communication unit, and the information obtained by the acquisition unit with each other and records the associated information on the recording unit.

9. An information acquisition system comprising:
a terminal apparatus configured to be hand held by a user when in use; and
an external device configured to be attached to the user when in use,
wherein the terminal apparatus includes:
a first acquisition unit configured to obtain first information;
a first communication unit configured to communicate with the external device, transmit the first information obtained by the first acquisition unit to the external device, and receive external device information obtained on the external device when the first acquisition unit obtains the first information; and
a first recording control unit configured to associate the external device information received via the first communication unit with the first information obtained by the first acquisition unit and record the associated information on a first recording unit, and
the external device includes:
a second acquisition unit configured to obtain the external device information;
a second communication unit configured to communicate with the terminal apparatus, transmit, to the terminal apparatus, the external device information obtained by the second acquisition unit when the first acquisition unit obtains the first information, and receive the first information obtained by the first acquisition unit, from the terminal apparatus; and
a second recording control unit configured to associate the first information received via the second communication unit with the external device information obtained by the second acquisition unit and record the associated information on a second recording unit.

10. An information acquisition method executed by a terminal apparatus including an acquisition unit configured to obtain information, the method comprising the steps of:
communicating with an external device;
transmitting the information obtained by the acquisition unit to the external device;
receiving external device information obtained on the external device when the acquisition unit obtains the information;
associating the received external device information with the information obtained by the acquisition unit; and
recording the associated information on a recording unit.

11. A non-transitory computer-readable recording medium with an executable program stored thereon, the program causing a processor of a terminal apparatus including an acquisition unit configured to obtain information to execute:
communicating with an external device;
transmitting the information obtained by the acquisition unit to the external device;
receiving external device information obtained on the external device when the acquisition unit obtains the information;
associating the received external device information with the information obtained by the acquisition unit; and
recording the associated information on a recording unit.
